(19) United States
(12) Patent Application Publication
(10) Pub. No.: US 2009/0097161 A1
(43) Pub. Date: Apr. 16, 2009

(54) HEAD ACTUATOR ASSEMBLY, DISK DEVICE PROVIDED WITH THE SAME, AND MANUFACTURING METHOD FOR HEAD ACTUATOR ASSEMBLY

(75) Inventors: Hitoshi Naruse, Musashino-shi (JP); Akio Toda, Uenohara-shi (JP); Kazuhiro Yoshida, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/240,304

(22) Filed: Sep. 29, 2008

(30) Foreign Application Priority Data
Oct. 12, 2007 (JP) 2007-266967

(51) Int. Cl. G11B 21/16; G11B 5/127

(52) U.S. Cl. 360/244.1; 29/603.07

(57) ABSTRACT

According to one embodiment, a disk device includes a disk, a drive section which is configured to support and rotate the disk, a head, and a head actuator assembly. The head actuator assembly includes a board unit including a base portion on which an electronic component is mounted, a main flexible printed circuit board which is configured to extend from the base portion and have a connecting end portion attached to the carriage, and a reinforcing plate including a bent portion fixed to the main flexible printed circuit board, and a vibration damper which is configured to include a sheet-shaped viscoelastic material stuck on the bent portion and a sheet-shaped reinforcing material, more rigid than the viscoelastic material and stuck on the viscoelastic material in superposed relation, and suppress vibration of the reinforcing plate.

### CROSS-REFERENCE TO RELATED APPLICATIONS

This application is based upon and claims the benefit of priority from Japanese Patent Application No. 2007-266967, filed Oct. 12, 2007, the entire contents of which are incorporated herein by reference.

### BACKGROUND

1. Field

One embodiment of this invention relates to a head actuator assembly including a carriage that supports a head, a disk device provided with the same, and a method of manufacturing the head actuator assembly.

2. Description of the Related Art

In recent years, disk devices, such as magnetic disk devices, optical disc devices, etc., have been widely used as external recording devices of computers or image recording apparatuses.

A disk device, e.g., a magnetic disk device, generally includes magnetic disks contained in a case, a spindle motor that supports and rotates the disks, a carriage that supports magnetic heads, a voice coil motor that drives the carriage, a flexible printed circuit board (FPC) unit, etc.

The carriage includes a bearing portion mounted on the case and a plurality of arms that are laminated on and extend from the bearing portion. A magnetic head is attached to each arm by means of a suspension. The FPC unit is formed integrally including a base portion, on which electronic components, connectors, etc., are mounted, and a main flexible printed circuit board (main FPC), which extends in a curve from the base portion to the vicinity of the bearing portion. An extended end portion of the main FPC constitutes a terminal area that is provided with a plurality of connection pads, and is screwed to the bearing portion of the carriage.

Further, a relay flexible printed circuit board (relay FPC) is fixed on each arm and each suspension of the carriage. One end of the relay FPC is connected to the magnetic head, and the other end to the terminal area of the main FPC. A plurality of connection pads are provided on the other end of each relay FPC. The relay FPC and the main FPC are connected electrically and mechanically to each other by soldering these connection pads to the ones on the terminal area side of the main FPC. Thus, the magnetic heads supported individually on the suspensions are electrically connected to the FPC unit through the relay FPCs and the main FPC.

When each magnetic disk rotates at high speed in the magnetic disk device, an airflow in the same direction of rotation as the disk is generated. The main FPC that extends from the base portion to the carriage of the head actuator is shaken by a flow of wind in the magnetic disk device and a swing of the actuator. Accordingly, the main FPC causes a resonance and worsens the positioning accuracy of the actuator, thereby hindering the achievement of a high recording density.

Proposed in Jpn. Pat. Appln. KOKAI Publication No. 8-287625, therefore, is a device in which a loop portion of a main FPC is provided with a sponge material for use as a vibration damper, whereby vibration of the main FPC can be suppressed to improve the positioning accuracy of a head actuator, for example. Proposed in Jpn. Pat. Appln. KOKAI Publication No. 5-074070, moreover, is a device in which a viscoelastic plate is bonded between a fixed portion and a bent portion of an FPC, for example.

If the sponge material or viscoelastic plate is only bonded to the FPC in the manner described above, however, it is difficult to fully suppress vibrations of the main FPC and a liner plate portion that constitutes the bent portion of the FPC unit. Thus, there is a demand for secure suppression of the vibrations of the main FPC and the bent portion.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view showing an HDD according to an embodiment of the invention with its top cover off;

FIG. 2 is an exemplary perspective view showing a head actuator assembly of the HDD;

FIG. 3 is an exemplary plan view showing a development of a board unit of the HDD;

FIG. 4 is an exemplary sectional view of the board unit taken along line IV-IV of FIG. 2;

FIG. 5 is an exemplary side view showing a bent portion and a vibration damper of the board unit;

FIG. 6 is an exemplary sectional view of bent portion and the vibration damper taken along line VI-VI of FIG. 5;

FIG. 7 is an exemplary plan view showing a vibration damping tape for the vibration damper;

FIG. 8 is an exemplary sectional view of the vibration damping tape taken along line VIII-VIII of FIG. 7; and

FIG. 9 is an exemplary sectional view corresponding to FIG. 6, showing a bent portion and a vibration damper of a board unit according to another embodiment of the invention.

### DETAILED DESCRIPTION

Various embodiments according to the invention will be described hereinafter with reference to the accompanying drawings. In general, according to one embodiment of the invention, there is provided a head actuator assembly comprising: a board unit including a base portion on which an electronic component is mounted, a main flexible printed circuit board which is configured to extend from the base portion and include a connecting end portion attached to a carriage, and a reinforcing plate having a bent portion fixed to the main flexible printed circuit board; and a vibration damper which is configured to include a sheet-shaped viscoelastic material stuck on the bent portion and a sheet-shaped reinforcing material, more rigid than the viscoelastic material and stuck on the viscoelastic material in superposed relation, and suppress vibration of the reinforcing plate.

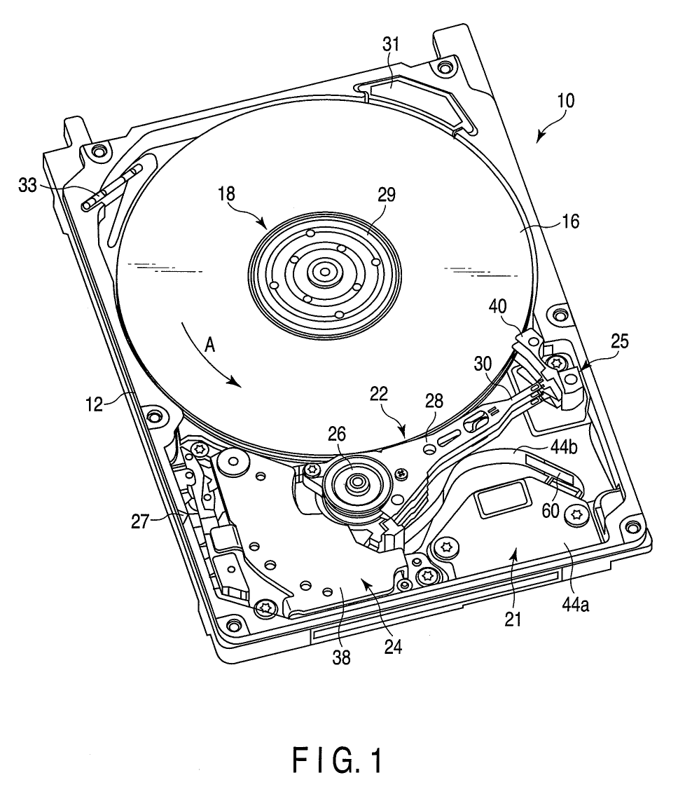

An HDD according to an embodiment of this invention will now be described in detail with reference to the accompanying drawings. FIG. 1 shows the internal structure of the HDD with its top cover off. As shown in FIG. 1, the HDD is provided with a case 10. The case 10 includes a base 12 in the form of an open-topped rectangular box and a top cover (not shown), which is fastened to the base by screws so as to close the top opening of the base.

The case 10 contains a spindle motor 18 mounted on a bottom wall of the base 12 and two magnetic disks 16 that are supported and rotated by the spindle motor. Further, the case 10 contains magnetic heads 17, carriage 22, voice coil motor (VCM) 24, ramp load mechanism 25, inertia latch mechanism 27, and board unit 21. The magnetic heads 17 record and reproduce information to and from the magnetic disks 16. The carriage 22 supports the heads 17 for movement with respect to the disks 16. The VCM 24 rocks and positions the carriage. The ramp load mechanism 25 holds the magnetic heads in a retracted position at a distance from the magnetic disks when the heads are moved to the outermost peripheries of the disks. The inertia latch mechanism 27 holds the carriage in its retracted position when the HDD is jolted. The board unit 21 includes a preamplifier and the like. A printed circuit board (not shown) is screwed to the outer surface of the bottom wall of the base 12. The circuit board controls the operations of the spindle motor 18, VCM 24, and magnetic heads through the board unit 21.

Each magnetic disk 16 is formed with a diameter of, for example, 65 mm (2.5 inches) and has magnetic recording layers on its upper and lower surfaces, individually. The two magnetic disks 16 are coaxially fitted on a hub (not shown) of the spindle motor 18 and clamped and fixed on the hub by a clamp spring 29. Thus, the magnetic disks 16 are supported parallel to the bottom wall of the base 12. The disks 16 are rotated at a predetermined speed of, for example, 5,400 or 7,200 rpm in the direction of arrow A by the spindle motor 18 for use as a drive section.

The HDD is provided with a breather filter 31 and a circulation filter 33. The breather filter 31 removes dust, moisture, and gas components from the open air introduced through air vents in the top cover. The circulation filter 33 captures dust that is produced in a housing when any moving part is operated. These filters 31 and 33 are arranged around the magnetic disks 16.

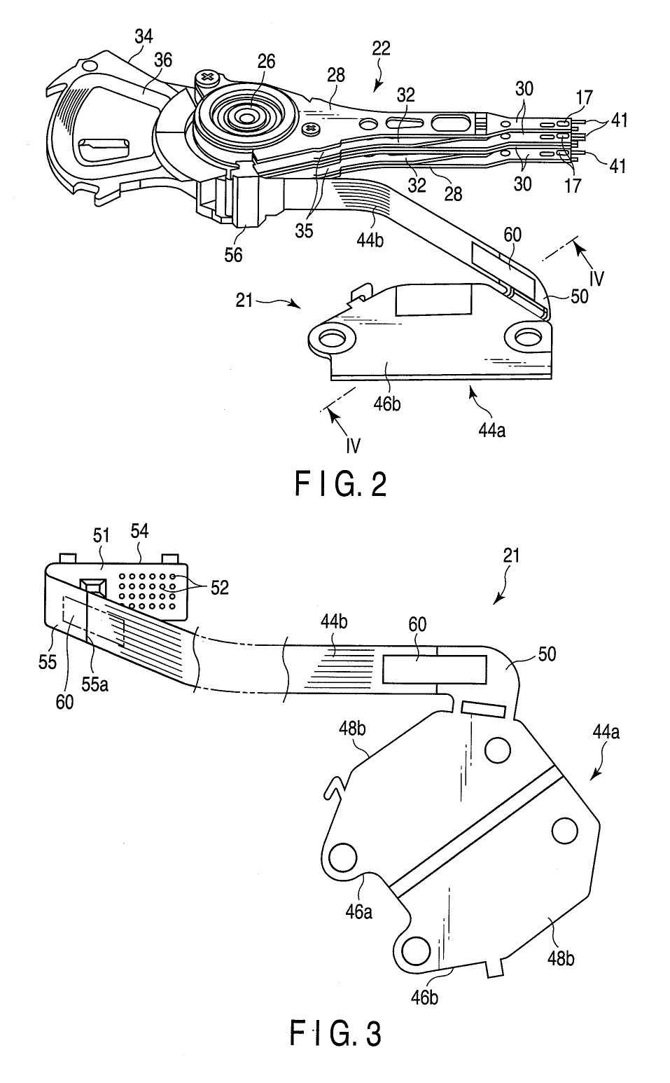

As shown in FIGS. 1 and 2, the carriage 22 is provided with a bearing portion 26, which is fixed on the bottom wall of the base 12, and four arms 28 that extend from the bearing portion. The bearing portion 26 is situated apart from the center of rotation of each magnetic disk along the length of the base 12 and near the outer peripheral edge of the disk. The four arms 28 are situated parallel to the surfaces of the magnetic disks 16 and spaced from one another. Further, they extend in the same direction from the bearing portion 26. The carriage 22 is provided with suspensions 30 that are elastically deformable elongated plates. Each suspension 30 is formed of a leaf spring, of which the proximal end is fixed to the distal end of its corresponding arm 28 by spot welding or adhesive bonding and which extends from the arm. Alternatively, each suspension may be formed integrally with its corresponding arm 28.

The magnetic heads 17 are mounted on respective extended ends of the suspensions 30. Each magnetic head 17 includes a substantially rectangular slider and a recording/reproducing magnetoresistive (MR) head formed on the slider. Each magnetic head 17 is fixed to a gimbal portion that is formed on the distal end portion of each suspension 30. The four magnetic heads 17 mounted on their corresponding suspensions 30 are opposed to one another in pairs and arranged so as to hold each magnetic disk 16 from both sides.

Each magnetic head 17 is electrically connected to a main FPC 44b (mentioned later) through a relay flexible printed circuit board (relay FPC) 32. The relay FPC 32 is stuck on the respective surfaces of each arm 28 and each suspension 30 of the carriage 22 and extends from the distal end of the suspension to the rocking proximal end of the arm. The relay FPC 32 is in the form of an elongated belt as a whole, and its distal end is electrically connected to an electrode of the magnetic head 17. The proximal end portion of the relay FPC 32 extends outward from the proximal end of the magnetic head 17 and constitutes a terminal area 35 that includes a plurality of connection pads. The respective terminal areas 35 of the relay FPCs 32 are electrically connected to a terminal area of the main FPC.

The carriage 22 includes a support frame 34 that extends from the bearing portion 26 oppositely from the arms 28. The support frame supports a voice coil 36 that constitutes a part of the VCM 24. The support frame 34 is molded from a synthetic resin and formed integrally on the outer periphery of the voice coil 36. The voice coil 36 is situated between a pair of yokes 38 that are fixed on the base 12 and, in conjunction with these yokes and a magnet (not shown) fixed to one of the yokes, constitutes the VCM 24.

If the voice coil 36 is energized, the carriage 22 rocks around the bearing portion 26, whereupon each magnetic head 17 is moved to and positioned in a region over a desired track of the magnetic disk 16. Thus, the head 17 can write or read information to or from the disk 16. The carriage 22 and the VCM 24 constitute a head actuator.

The ramp load mechanism 25 includes a ramp 40 and tabs 41. The ramp 40 is provided on the bottom wall of the base 12 and located outside the magnetic disk 16. The tabs 41 extend individually from the respective distal ends of the suspensions 30. The ramp 40 is situated on the downstream side of the bearing portion 26 with respect to the direction of rotation A of the magnetic disk 16. As the carriage 22 rocks to its retracted position outside the magnetic disk 16, each tab 41 engages with a ramp surface formed on the ramp 40 and is then pulled up along the slope of the ramp surface, whereupon each magnetic head is unloaded.

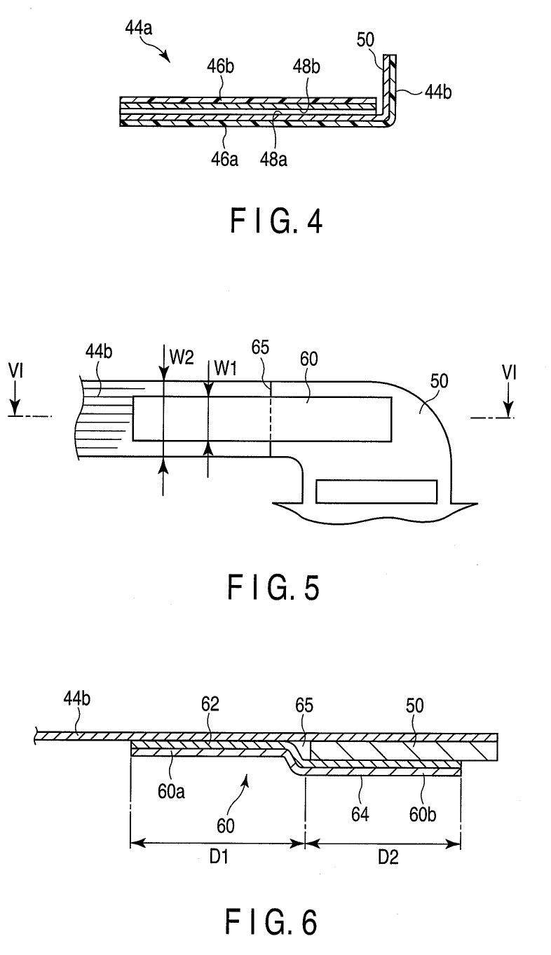

As shown in FIGS. 2, 3 and 4, the board unit 21 includes a base portion 44a formed of a flexible printed circuit board and the belt-shaped main flexible printed circuit board (main FPC) 44b extending in a loop from the base portion. The base portion 44a includes a first base 46a and a second base 46b that are substantially rectangular. The first and second bases 46a and 46b are internally lined with liner plates 48a and 48b, respectively, which are shaped corresponding to the bases. These liner plates 48a and 48b, which function as reinforcing plates, are formed of, for example, aluminum or the like.

Electronic components (not shown), such as a head amplifier, capacitor, connector, etc., are mounted on the first and second bases 46a and 46b. The first and second bases 46a and 46b are folded and joined together so as to face each other. In this state, the base portion 44a is fixedly screwed to the bottom wall of the base 12.

The liner plate 48a integrally includes a bent portion 50 that extends outward from its side edge and is bent substantially at right angles to the base portion 44a.

The main FPC 44b extends from the first base 46a. The proximal end portion of the main FPC 44b is bent and raised substantially at right angles to the first base 46a and stuck on the bent portion 50 of the liner plate 48a. Thus, the proximal end portion of the main FPC 44b is kept bent with respect to the base portion 44a.

An extended end of the main FPC 44b constitutes a connecting end portion 51, which is fixed to the vicinity of the bearing portion 26. A plurality of pads 52 are formed on the connecting end portion 51. The respective terminal areas 35 of the relay FPCs 32 are electrically connected to the pads 52 of the connecting end portion 51. Thus, the magnetic heads 17 are electrically connected to the base portion 44a through the relay FPCs 32 and the main FPC 44b.

A liner plate 54 of, for example, aluminum is stuck as a reinforcing plate on the reverse side of the connecting end portion 51. The liner plate 54 includes a turn-up portion 55 that is turned up from near the connecting end portion 51 toward the base portion 44a. The extended end portion of the main FPC 44b is stuck on the turn-up portion 55 and held on the connecting end portion 51 by a hook 56. Thus, the extended end portion of the main FPC 44b is kept turned up from the connecting end portion 51 toward the base portion 44a.

The board unit 21 constructed in this manner is connected to the carriage 22 and, in conjunction with the carriage, constitutes a head actuator assembly. The bent portion 50 and the main FPC 44b of the board unit 21 are provided with a vibration damper 60.

As shown in FIGS. 2 to 6, the vibration damper 60 includes a viscoelastic material 62 and a reinforcing material 64. The viscoelastic material 62 is an elongated rectangular sheet stuck on the bent portion 50 and the main FPC 44b. The reinforcing material 64 is a rectangular sheet that is more rigid than the viscoelastic material 62 and stuck to the viscoelastic material 62 in superposed relation. The reinforcing material 64 has the same shape as the viscoelastic material 62 and is superposed on its entire surface.

For example, Sumitomo 3M-VEM (trademark), an acrylic polymer, can be used for the viscoelastic material 62. A synthetic resin, such as polyimide, or a metal plate of aluminum or the like can be used for the reinforcing material 64. In this case, a polyimide sheet is used for the reinforcing material 64 to maintain the flexibility of the main FPC 44b, so that the main FPC can be deformed freely.

A width W1 of the vibration damper 60 is smaller than a width W2 of the main FPC 44b and the bent portion 50. The vibration damper 60 is stuck on the bent portion 50 and the main FPC 44b so as to straddle a boundary 65 between the bent portion and the main FPC. The vibration damper 60 is formed so that a length D1 of its portion 60a stuck on the main FPC 44b is larger than a length D2 of its portion 60b stuck on the bent portion 50.

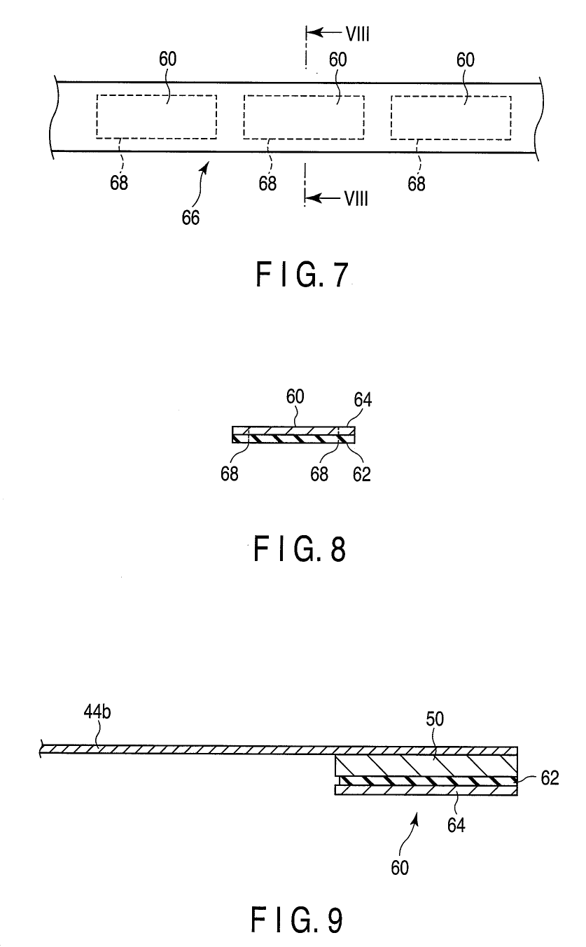

The vibration damper 60 is formed by the following process and fixed in a predetermined position on the board unit 21. First, an elongated, belt-shaped vibration damping tape 66 is prepared, as shown in FIGS. 7 and 8. The vibration damping tape 66 includes a belt-shaped tape of the reinforcing material 64 formed of, for example, polyimide, and the viscoelastic material 62 that is stuck on one entire surface of the material tape. The vibration damping tape 66 is formed with a width larger than the width W1 of the vibration damper 60. Further, perforations 68 corresponding in size to each vibration damper 60 are formed in the vibration damping tape 66. These perforations are arranged at very short intervals along the length of the vibration damping tape. The vibration damper 60 can be easily cut off along the perforations 68.

The vibration damper 60 is cut out of the vibration damping tape 66 and stuck at a predetermined position on the board unit 21, that is, on the respective proximal end portions of the bent portion 50 and the main FPC 44b in this case, in superposed relation. When this is done, the vibration damper 60 can be easily stuck at a desired position without projecting from the bent portion 50 and the main FPC 44b, since the width W1 of the damper is smaller than the width W2 of the bent portion and the main FPC.

According to the head actuator assembly constructed in this manner and the HDD provided with the same, vibration of the bent portion 50 of the metallic liner plate can be suppressed by the vibration damper 60, and in addition, vibration of the main FPC 44b itself can be suppressed. Thus, vibration that acts on the head actuator through the main FPC can be reduced to improve the positioning accuracy of the head actuator. Further, the viscoelastic material and the reinforcing material that is superposed thereon are used for the vibration damper, so that deformation of the viscoelastic material can be prevented by the reinforcing material. Thus, a higher vibration damping effect can be obtained by converting the deformation of the viscoelastic material, which is attributable to the vibrations of the bent portion and the main FPC, into thermal energy.

A relatively flexible material, such as a synthetic resin, is used as the reinforcing material. Thus, the movement of the main FPC that is caused by the rocking motion of the carriage cannot be hindered by the vibration damper, so that breakage or the like of the main FPC can be prevented. At the same time, in a control process, the efficiency of operation for sticking the vibration damper on the board unit can be improved.

Accordingly, there can be obtained a head actuator assembly, configured so that vibration of an FPC unit can be more securely prevented to improve the positioning accuracy of a head actuator, a disk device provided with the same, and a manufacturing method for the head actuator assembly.

In the embodiment described above, the vibration damper 60 is configured to be stuck on the bent portion 50 of the liner plate and the proximal end portion of the main FPC 44b so as to straddle them. Alternatively, however, a vibration damper 60 may be stuck on a bent portion 50 only, as in a second embodiment shown in FIG. 9. Also in this case, the vibration damper 60 can suppress vibration of the bent portion 50, thereby suppressing vibration of the main FPC 44b.

Other configurations of the board unit shown in FIG. 9 are the same as those of the foregoing embodiment, so that like reference numbers are used to designate like portions, and a detailed description thereof is omitted.

As indicated by a two-dot and dashed line in FIG. 3, moreover, the vibration damper 60 may be stuck on the turn-up portion 55 of the liner plate 54 or on the turn-up portion 55 and the extended end portion of the main FPC 44b. In this case, the vibration damper 60 is stuck on the turn-up portion 55 and the extended end portion of the main FPC 44b so as to straddle a boundary 55a between them. Thus, the vibration damper 60 may be stuck either on only the extended end side of the main FPC 44b or on both the extended end and proximal end sides.

Also in this arrangement, the vibration damper 60 can suppress the vibrations of the turn-up portion 55 and the main FPC, thereby reducing the vibration that acts on the head actuator assembly through the main FPC, so that the positioning accuracy of the head actuator assembly can be improved.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

Although the HDD of the foregoing embodiments have been described as including two magnetic disks, for example, the number of magnetic disks to be incorporated can be varied as required.

What is claimed is:

1. A head actuator assembly comprising:
a board unit comprising a base portion on which an electronic component is mounted, a main flexible printed circuit board extending from the base portion and comprising a connecting end portion attached to a carriage, and a reinforcing plate comprising a bent portion fixed to the main flexible printed circuit board; and
a vibration damper comprising a first sheet of viscoelastic material attached to the bent portion and a second sheet of reinforcing material harder than the viscoelastic material and attached to the first sheet, and the vibration damper configured to suppress vibration of the reinforcing plate.

2. The head actuator assembly of claim 1, wherein the second sheet is made of either a synthetic resin or a metal, and is attached to the first sheet in order to cover the entire surface of the second sheet.

3. The head actuator assembly of claim 1, wherein the vibration damper is attached to the bent portion and the main flexible printed circuit board in order to straddle a boundary between the bent portion and the main flexible printed circuit board.

4. The head actuator assembly of claim 3, wherein the width of the vibration damper is smaller than that of the main flexible printed circuit board and the bent portion.

5. The head actuator assembly of claim 3, wherein the portion of the vibration damper attached to the main flexible printed circuit board is larger than the portion of the vibration damper attached to the bent portion.

6. The head actuator assembly of claim 1, wherein the reinforcing plate is fixed to the base portion and the bent portion is attached to an end portion of the main flexible printed circuit board.

7. The head actuator assembly of claim 1, wherein the main flexible printed circuit board comprises a folded portion from near the connecting end portion toward the base portion, and the reinforcing plate is fixed to the connecting end portion and attached to the bent portion of the main flexible printed circuit board.

8. The head actuator assembly of claim 1, wherein the carriage is provided with a bearing portion, an arm extending from the bearing portion, a suspension extending from an extended end of the arm, a head mounted on the extended end of the suspension, and a relay flexible printed circuit board having one end portion electrically connected to the head and a terminal area connected to the connecting end portion of the main flexible printed circuit board.

9. A disk device comprising:
a disk;
a drive section configured to support and rotate the disk;
a head configured to record information to the disk and to reproduce the information from the disk; and
a head actuator assembly configured to support the head and to move the head in a position with respect to the disk,
the head actuator assembly comprising a board unit comprising a base portion on which an electronic component is mounted, a main flexible printed circuit board extending from the base portion and comprising a connecting end portion attached to a carriage, and a reinforcing plate comprising a bent portion fixed to the main flexible printed circuit board, and a vibration damper comprising a first sheet of viscoelastic material attached to the bent portion and a second sheet of reinforcing material harder than the viscoelastic material and attached to the first sheet, and the vibration damper configured to suppress vibration of the reinforcing plate.

10. The disk device of claim 9, wherein the second sheet is made of either a synthetic resin or a metal, and is attached to the first sheet in order to cover the entire surface of the second sheet.

11. The disk device of claim 9, wherein the vibration damper is attached to the bent portion and the main flexible printed circuit board in order to straddle a boundary between the bent portion and the main flexible printed circuit board.

12. A method of manufacturing a head actuator assembly provided with a board unit comprising a base portion on which an electronic component is mounted, a main flexible printed circuit board extending from the base portion and comprising a connecting end portion attached to the carriage, and a reinforcing plate comprising a bent portion fixed to the main flexible printed circuit board, and a vibration damper comprising a first sheet of viscoelastic material attached to the bent portion and a second sheet of reinforcing material harder than the viscoelastic material and attached to the first sheet, and the vibration damper configured to suppress vibration of the reinforcing plate, the method comprising:
providing a belt-shaped vibration damping tape comprising the viscoelastic material attached to a reinforcing material tape in the form of an elongated sheet;
cutting out the vibration damper in a desired shape from the vibration damping tape; and
attaching the cut-out vibration damper at a predetermined position on the bent portion of the reinforcing plate with the viscoelastic material in contact with the bent portion.
